(19) United States
(12) Patent Application Publication
(10) Pub. No.: US 2024/0141223 A1
(43) Pub. Date: May 2, 2024

(54) ENVIRONMENTALLY FRIENDLY NANOSHALE INHIBITOR IN AQUEOUS-BASED WELLBORE FLUIDS

(71) Applicant: SAUDI ARABIAN OIL COMPANY, Dhahran (SA)

(72) Inventors: Hassan Sakar Alqahtani, Dammam (SA); Mohammed Khaled Al-Arfaj, Dammam (SA); Mohammed Faisal Alhassni, Khobar (SA); Mohammed Abdullah Otaibi, Dhahran (SA)

(73) Assignee: SAUDI ARABIAN OIL COMPANY, Dhahran (SA)

(21) Appl. No.: 18/496,760

(22) Filed: Oct. 27, 2023

Related U.S. Application Data
(60) Provisional application No. 63/381,834, filed on Nov. 1, 2022.

(51) Int. Cl. C09K 8/03; C09K 8/06; E21B 21/00

(52) U.S. Cl. CPC C09K 8/032; C09K 8/06; E21B 21/00; C09K 2208/06; C09K 2208/10; C09K 2208/12

(57) ABSTRACT

A wellbore fluid composition includes an aqueous base fluid and mesoporous silica nanoparticles (MSNs). The MSNs are encapsulated in a surfactant. A method of drilling a wellbore includes circulating an aqueous drilling fluid into the wellbore while drilling and recovering shale cuttings from the aqueous drilling fluid. The aqueous drilling fluid includes mesoporous silica nanoparticles encapsulated by a surfactant.

### BACKGROUND

During drilling operations, a drilling fluid, which may also be referred to as drilling mud, is circulated through the wellbore to cool and lubricate the drill bit, maintain the rheology of the fluids, manage hydrostatic pressure in the wellbore, prevent fluid loss into the formation, transport rock cuttings to the surface, and prevent the swelling of shale formation, among other purposes. Drilling fluids are formulated to have certain fluid characteristics, such as density and rheology, for example, that allow the drilling fluid to perform these functions. There are two major categories of drilling fluids—oil-based mud (OBM) and water-based mud (WBM). Oil-based drilling fluids have superior inhibition properties, excellent lubricity, and high-temperature stability. However, the high cost and the increasing concerns of environmental toxicity have led to a reduction of OBMs in drilling operations. WBMs pose a relatively lower environmental threat in comparison to OBMs while maintaining ideal rheological properties and performance. However, the use of WBMs in the presence of reactive shales often detrimentally impacts the wellbore integrity.

In particular, shale swelling, often experienced with WBMs, leads to instability during well drilling by causing issues such as sloughing, bit balling, caving, high drag and torque, stuck pipe, and disintegration of shale cuttings due to water adsorption. In order to avoid such issues caused by shale swelling, additives, such as shale inhibitors may be included in the WBM formulation. Traditional shale inhibitors include various electrolytes such as sodium chloride, potassium chloride, and divalent brine electrolyte for water sensitive shale formations. However, these salts can adversely affect the eco-system by posing threat to the water as well as the soil quality.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a wellbore fluid composition including an aqueous base fluid and mesoporous silica nanoparticles (MSNs), wherein the MSNs are encapsulated in a surfactant.

In another aspect, embodiments disclosed herein relate to a method of drilling a wellbore, the method including circulating an aqueous drilling fluid into the wellbore while drilling, wherein the aqueous drilling fluid includes mesoporous silica nanoparticles (MSNs) encapsulated by a surfactant, and recovering shale cuttings from the aqueous drilling fluid.

Other aspects and advantages of the claimed subject matter will be apparent from the following description and the appended claims.

### BRIEF DESCRIPTION OF DRAWINGS

FIG. 1 is a transmission electron microscope image of mesoporous silica nanoparticles (MSNs) in accordance with one or more embodiments of the present disclosure.

FIG. 2 is a graphical depiction of thermal gravimetric analysis results of MSNs in accordance with one or more embodiments of the present disclosure.

FIG. 3 is an x-ray diffraction (XRD) pattern of a shale cutting in accordance with one or more embodiments of the present disclosure.

FIG. 4 is an XRD pattern of MSNs in accordance with one or more embodiments of the present disclosure.

### DETAILED DESCRIPTION

Embodiments in accordance with the present disclosure generally relate to a composition and method of making an aqueous fluid comprising a shale inhibitor and a method of its use in wellbore fluid. The disclosed composition includes a shale inhibitor that may be a mesoporous framework including mesoporous silica nanoparticles (MSNs). In particular, the shale inhibitor includes MSNs encapsulated in a surfactant. The disclosed MSNs are stable in high salinity brines at elevated temperature.

Wellbore Fluid Composition

In one aspect, embodiments of the present disclose relate to a wellbore fluid composition. The wellbore fluid composition may include mesoporous silica nanoparticles (MSNs) suspended in an aqueous base fluid. MSNs in accordance with the present disclosure are used as a shale inhibitor in the disclosed wellbore fluid.

The MSNs may be encapsulated in a surfactant, such as a cationic surfactant, an anionic surfactant, or a nonionic surfactant. In one or more embodiments, the MSNs are encapsulated in a cationic surfactant such as, for example, cetyltrimethylammonium bromide (CTAB).

As will be appreciated by one of ordinary skill in the art, MSNs are silica-based particles that have pores. As used herein “pores” refer to void spaces in the particle. In one or more embodiments, the MSNs have pores having an average diameter of from about 2 to 50 nm (nanometers). In some embodiments, the pores may be in the shape of extended cylinders.

In one or more embodiments, MSNs have a suitable organic content, as determined by thermal gravimetric analysis (TGA). As the primary component of the MSNs, silica, is inorganic, the organic content of the MSNs may indicate the amount of surfactant present, and thus indicate if the MSNs are completely encapsulated in surfactant. An organic content indicating complete encapsulation in the surfactant may range from about 30 to 50 wt %, based on the total weight of the MSNs. For example, MSNs that are fully encapsulated in a surfactant may have an organic content ranging from a lower limit of one of 30, 32, 34, 36, 38, and 40 wt %, to an upper limit of one of 40, 42, 44, 46, 48, and 50 wt %, where any lower limit may be paired with any mathematically compatible upper limit. In particular embodiments, MSNs have an organic content of about 40 wt %, based on the total weight of the MSNs.

In one or more embodiments, the wellbore fluid includes MSNs having a suitable size. MSNs included in disclosed wellbore fluids may have an average particles size ranging from about 100 to about 200 nm. For example, wellbore fluids of one or more embodiments include MSNs having an average particle size ranging from a lower limit of one of 100, 110, 120, 130, 140, 150, 160, and 180 nm to an upper limit of one of 130, 140, 150, 160, 170, 180, 190 and 200 nm, where any lower limit may be paired with any mathematically compatible upper limit. In particular embodiments, the MSNs have an average particle size of about 200 nm.

In one or more embodiments, the wellbore fluid includes MSNs that are commercially available or well known in the art, such as, for example, MCM-41 (available from Mobil Corp).

As described above, in the wellbore fluid of one or more embodiments, the MSNs are suspended in an aqueous base fluid. Suitable aqueous base fluids include, for example, water-based wellbore fluids, such as water-based drilling muds (WBMs), or completion fluids, among others.

The wellbore fluid of one or more embodiments include MSNs as a shale inhibitor in an amount ranging from about 0.2 to 10 percent by weight (wt. %) based on the total weight of the wellbore fluid. For example, the wellbore fluid may contain the MSNs as a shale inhibitor in an amount ranging from a lower limit of any of 0.2, 0.3, 0.5, 0.7, 0.8, 1.0, 1.5, 2.0, and 2.5 wt. % to an upper limit of any of 0.5, 1.0, 1.5, 2.0, 2.5, 5.0, 7.5, and 10.0 wt. %, where any lower limit can be used in combination with any mathematically-compatible upper limit. In particular embodiments, the wellbore fluid may contain the shale inhibitor in an amount of about 1 to 10 wt. % of the total weight of the wellbore fluid.

Further, other additives may be included in the wellbore fluids of the present disclosure Such additives may include, for instance, one or more of the groups consisting of weighting agents, viscosifiers, wetting agents, corrosion inhibitors, oxygen scavengers, anti-oxidants, biocides, surfactants, dispersants, interfacial tension reducers, pH buffers, mutual solvents and thinning agents. The wellbore fluids of one or more embodiments may have a pH range from about 6.5 to about 7.5. Weighting agents suitable for use in the wellbore fluids of one or more embodiments include, for example, bentonite, barite, dolomite, calcite, and the like. The identities and use of the aforementioned additives are not particularly limited. One of ordinary skill in the art will, with the benefit of this disclosure, appreciate that the inclusion of a particular additive will depend upon the desired application, and properties, of a given wellbore fluid.

The rheological properties of a wellbore fluid are important in determining the suitability of the fluid for a given application.

The plastic viscosity of a fluid is a measure of the resistance of the fluid to flow. For instance, drilling fluids that have a lower plastic viscosity have the capacity to drill more quickly. Plastic viscosity is dependent on both the solid content of a fluid and temperature. The wellbore fluid of one or more embodiments may have a plastic viscosity ranging from about 3.0 to 6.0 cP at room temperature. As used herein, “room temperature” refers to the temperature of the ambient environment. Generally, room temperature may be considered to be about 23° C., but may range from about 20° C. to about 28° C. The viscosity measurements described as being conducted at room temperature were conducted at about 23° C. For example, the wellbore fluid may have a plastic viscosity that ranges from a lower limit of any of 3.0, 3.5, 4.0, and 4.5 cP to an upper limit of any of 4.0, 4.5, 5.0, 5.5, and 6.0 cP, where any lower limit can be used in combination with any mathematically compatible upper limit.

The wellbore fluid of one or more embodiments may have an initial gel strength, such as a gel strength measured after 10 seconds, ranging from about 1.0 to 5.0 lb/100 ft² (pounds per 100 square feet). For example, the wellbore fluid may have an initial gel strength that ranges from a lower limit of any of 1.0, 1.5, 2.0, and 2.5 lb/100 ft² to an upper limit of any of 3.0, 3.5, 4.0, 4.5, and 5.0 lb/100 ft², where any lower limit can be used in combination with any mathematically compatible upper limit.

The wellbore fluid of one or more embodiments may have a final gel strength, such as a gel strength measured after 10 minutes, ranging from about 1 to 5 lb/100 ft². For example, the wellbore fluid may have a final gel strength that ranges from a lower limit of any of 1.0, 1.5, 2.0, and 2.5 lb/100 ft² to an upper limit of any of 3.0, 3.5, 4.0, 4.5, and 5.0 lb/100 ft², where any lower limit can be used in combination with any mathematically compatible upper limit.

The yield point is the resistance of a fluid to initiate movement and is an assessment of the strength of the attractive forces between the colloidal particles of the fluid. The yield point, for instance, demonstrates the capability of a drilling fluid to raise shale cuttings out of a borehole under dynamic conditions. A fluid with a higher yield point provides better carrying capacity as compared to a fluid with similar density and lower yield point. The wellbore fluid of one or more embodiments may have a yield point ranging from about 5 to 15 lb/100 ft². For example, the wellbore fluid may have a plastic viscosity that ranges from a lower limit of any of 5.0, 6.0, 7.0, 8.0, 9.0 and 10 lb/100 ft² to an upper limit of any of 10, 11, 12, 13, 14, and 15 lb/100 ft², where any lower limit can be used in combination with any mathematically compatible upper limit.

Reactive shales, when in contact with water-based drilling fluids, tend to swell as they are susceptible to hydration. As one skilled of the art may appreciate, shale inhibitors suppress this hydration, thereby reducing the swelling of the shale. As such, a hydration suppression test may be performed to evaluate the shale inhibition performance of a proposed shale inhibitor. Embodiments of the present disclosure include the MSNs described above as the proposed shale inhibitor.

A test to determine the rolling recovery of shale may be conducted to evaluate the performance of a shale inhibitor in one or more embodiments. Such rolling recovery tests include mixing an amount of shale with an aqueous wellbore fluid including the proposed shale inhibitor, hot rolling the mixture under predetermined conditions, sieving using 4-micron or 5-micron sieves, washing the shale collected that did not pass through the sieve. Processed shale cuttings are then dried and weighed. A higher rolling recovery is indicative of low shale erosion from the aqueous wellbore fluid. The wellbore fluid of one or more embodiments may have a rolling recovery of shale cuttings of greater than 80%, greater than 85%, greater than 90%, or greater than 95%.

Wellbore fluids in accordance with the present dislcsoure may be used as one or more of a drilling or drill-in fluid during the drilling of a wellbore, as a completion fluid for the completion of a wellbore after drilling is completed, and a workover fluid that is used for well workover.

Method of Drilling a Wellbore

In another aspect, embodiments of the present disclosure relate to a method of drilling a wellbore. The method may include circualting a drilling fluid into a wellbore while drilling and recovering shale cuttings while maintainin wellbore stability. The drilling fluid may be a wellbore fluid as previously described. As such, the drilling fluid of one or more embodiments includes an aqueous base fluid and a shale inhibtor composed of MSNs encapsulated in a surfactant.

As described above, in one or more embodiemnts, the method of drilling a wellbore initially includes circulating a drilling fluid into a wellbore. The drillling fluid may be circulated into a wellbore using techniques known to a person of ordinary skill in the art. In one or more embodiments, the drilling fluid is circulated into the wellbore while drilling.

Then, the method includes recovering shale cuttings while maintaining wellbore stability. Recovery of shale cuttings may be carried out accoridng to techniques known in the art. The shale cuttings may be recovered in an amount that indicates low shale erosion during drilling. For example, in one or more embodiments, the method of drilling in accordacne with the present disclosure may result in a shale recovery of greater than 80%, greater than 85%, greater than 90%, or greater than 95%.

Embodiments of the present disclosure may provide at least one of the following advantages. MSNs in accordance with the present disclosure provide a more efficient and sustainable alternative to conventional shale inhibitors, such as KCl (potassium chloride). The use of silica nanoparticles and an organic surfactant as a shale inhibitor in wellbore fluids eliminates the need for high KCl concentration, which, due to its caustic nature, leads to several equipment problems such as bit balling. Accordingly, the use of wellbore fluids including MSNs as shale inhibitor in accordance with the present disclosure may enhance the wellbore stability, mitigate shale drilling problems, and reduce well construction cost.

### EXAMPLES

Materials and Methods

Shale samples from the Lower Silurian period were collected from fields and used in these experiments. MCM-41 was synthesized according to techniques known in the art. Briefly, cetyltrimethylammonium bromide (CTAB), supplied by Sigma Aldrich, was dissolved in 480 mL of 18.2 DI (deionized) water. The mixture was stirred until all the CTAB was dissolved. An NaOH solution (2 M) was prepared in 18.2 DI water, and 3.5 mL was added to the beaker containing CTAB and water, and the temperature was then adjusted to 80° C. After that, 5 mL tetraethylorthosilicate was added dropwise while maintaining vigorous stirring of the solution. The mixture was stirred for two hours. The resultant white precipitate was collected, washed several times with DI water, and centrifuged at 9,000 rev/min for 15 minutes. The powder was then dried at 50° C. for two days. Finally, the MSNs were homogenously mixed with xanthan gum (1 g) and saline water (350 mL with 57000 TDS NaCl) at different concentrations. Example 1 included saline water and 0.75 g of MSNs, Example 2 included saline water and 1.5 g of MSNs, and Example 3 included saline water and 3.0 g of MSNs.

TEM Measurements

Transmission electron microscopy (TEM) is a high-resolution tool used to study the morphology and structure of nanomaterials. To reveal the silica spheres, the synthesized MSNs were characterized using TEM methods on a Morgagni 268, FEI at 80 keV. For this purpose, the dispersion of prepared MSNs were deposited onto TEM grids coated with lacy carbon film with nano-sized holes.

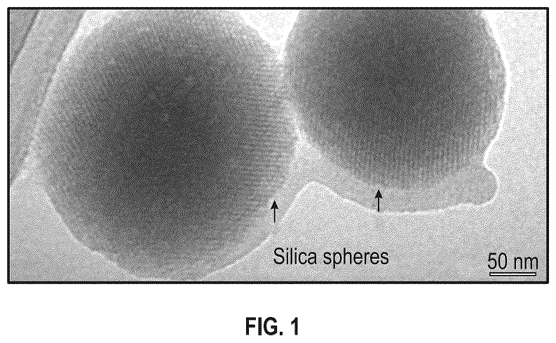

The TEM grids were dried before being transferred onto the microscope for examination. The particle size of the MSNs were measured from TEM images using Gatan digital micrograph software and represented as size histograms. An exemplary TEM image is shown in FIG. 1. FIG. 1 shows that the MSNs have a spherical shape and an average size of around 200 nm.

Thermal Gravimetric Analysis

Thermal gravimetric analysis (TGA) was performed to quantify the organic content present using the Q500 TA Instruments thermal analyzer with a heating rate of 10° C./min from 25° C. to 900° C. under nitrogen flow (10 mL min⁻¹). The instrument has an isothermal accuracy of ±1° C. The sample was crushed evenly, and about 10 mg of the powder was placed on the platinum pan and loaded into the TGA.

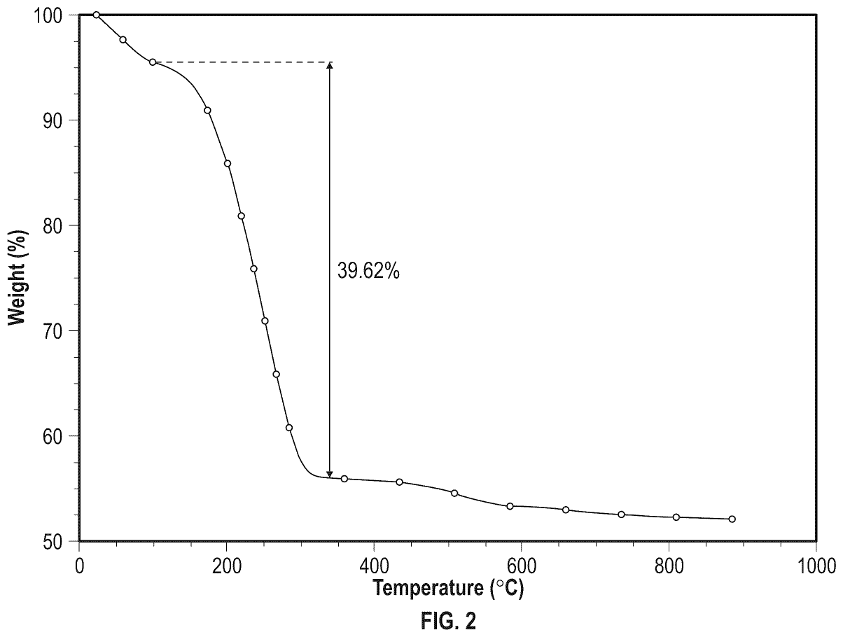

The exemplary MSNs are composed mainly of silicon dioxide and surfactant. Using TGA, the decomposition of the material can be used to indicate the amount of organic surfactant encapsulated. As shown in FIG. 2, the weight loss from 30° C. to 150° C. was a result of the desorption of the physically adsorbed water. Moreover, CTAB has been reported as beginning to decompose at around 200° C. Hence, the weight loss from 200° C. to 300° C. indicates the initial amount of surfactant in the MSNs. As shown in FIG. 2, approximately 40% of the total mass of the material was organic content in the MSNs, indicating complete CTAB encapsulation. The decomposition of silicon dioxide occurs at temperatures greater than 1,000° C., and was therefore not observed.

X-Ray Diffraction

X-ray diffraction (XRD) was used for mineralogy determination of the shale samples. Each sample was gently crushed using a mortar and pestle, then a McCrone micronizing mill was used to further grind the samples to 10-20 μm with the aid of a grinding agent (isopropanol) added to cool down the cell while grinding. Then, the samples were filtered under vacuum for 16 hours. Powder samples were measured using optimized angle range, slit size and speed scan conditions. These optimized conditions were necessary to accommodate the different type of samples that include mesoporous materials and clays. Rigaku X-ray powder diffractometer operated with a Copper X-ray tube was used. The semi-quantitative analysis was done using the Reference Intensity Ratio method using JADE 9 software.

In addition, a clay fraction from every sample was analyzed by preparing a slide sample from clay slurries. The procedure started by weighing an empty glass tube then loading the tube with a small amount of the sample in fine powder form. Again, the weight for the glass tube with the sample was recorded. Then, a few drops of sodium hexa meta phosphate (Calgon) were added to aid in dispersing the suspension after adding deionized water. The sample was then sonicated for 15 minutes to further break the sample particles down. After centrifuging the sample for 5 minutes, the suspension that contained clay was poured in plastic tube containing a few drops of 15% HCl to cause the clay minerals to flocculate. Then, the plastic tubes were centrifuged again at the same settings. The excess clear water was carefully decanted from the plastic tube. A small amount of distilled water was added to the clay in the bottom of the plastic tube. A small amount of fine powder from the mineral fluorite was also added as an internal standard to correct d-spacings for possible sample displacement errors. The clay slurry was poured onto the glass slide and left to dry in air. After that, the slide sample was run in the XRD instrument for a 2-theta range of 2°-32° with a step size of 2°/min. Upon completion of XRD run, the slide was glycolated to analyze the presence of any expandable clays. Slides were glycolated using ethylene glycol vapor at 60° C. overnight. The remaining contents of the glass tubes were again mixed with DI water and centrifuged several times until a clear suspension was achieved. The contents were dried in a 100° C. oven for 24 hours and then the weight was recorded to determine clay size fraction.

The XRD results with semiquantitative (wt %) results for shale sample are show in Table 1, below. The Lower Silurian period Shale samples were composed mainly of illite, chlorite and kaolinite. In kaolinite, the structure is arranged so that one tetrahedral sheet is followed by one octahedral sheet in a ratio of 1:1.

TABLE 1
Composition of Shale Samples Determined by XRD

| Detected Compound (by XRD) | wt % |
|---|---|
| Quartz (SiO₂) | 36 |
| Illite ((K, H₃O)Al₂(Si₃Al)O₁₀•H₂O) | 26 |
| Muscovite ((K, Na)(Al, Mg, Fe)₂(Si_{3.1}Al_{0.9})O₁₀(OH)₂) | 26 |
| Microcline (KAlSi₃O₈) | 11 |
| Albite (NaAlSi₃O₈) | — |
| Kaolinite (Al₂Si₂O₅(OH)₄) | 8 |
| Clinochlore (Mg, Al)₆(Si, Al)₄O₁₀(OH)₈) | 19 |

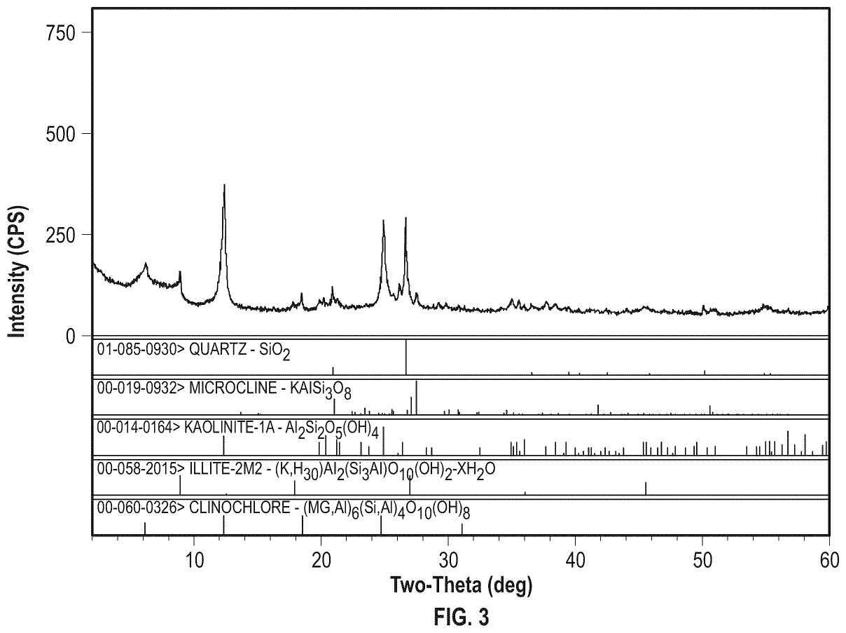

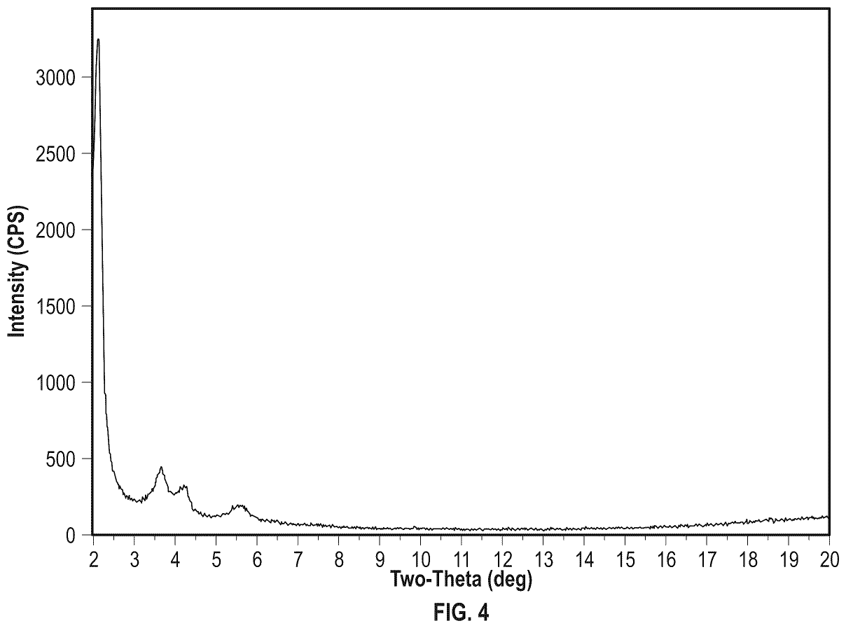

FIG. 3 shows the diffraction patters of shale samples with the representative shale composites. The XRD patterns of the exemplary MSNs are shown in FIG. 4. FIG. 4 shows multiple peaks at low angle assigned to MSNs reflections. The presence of these peaks can be attributed to the hexagonal lattice of MSN structure.

Fluid Rheology

The rheological properties of prepared drilling fluids were measured using a FANN 35 rheometer. The rheological properties of each different concentration of MSNs in drilling fluids at 120° F. before hot roll tests are shown in Table 2. In general, there was little to no difference in rheological properties, especially plastic viscosity (PV) and yield point (YP), between Examples 1-3, including MSNs and Comparative Example 1, without MSNs.

TABLE 2
Rheological Properties of Exemplary
and Comparative Drilling Fluids

| | | | | Comp. |
|---|---|---|---|---|
| Property | Example 1 | Example 2 | Example 3 | Ex. 1 |
| 600 RPM | 13.5 | 15.15 | 16.5 | 17.8 |
| 300 RPM | 10 | 10.65 | 11.7 | 13.8 |
| 200 RPM | 8 | 8.2 | 9.3 | 12.2 |
| 100 RPM | 5.35 | 5.4 | 6.6 | 9.8 |
| 6 RPM | 1.25 | 1.25 | 1.25 | 4.6 |
| 3 RPM | 1 | 1.5 | 2 | 3.7 |
| Plastic Viscosity (cP) | 3.5 | 4.5 | 4.8 | 3.9 |
| Yield Point (lb/100 ft²) | 6.5 | 6.15 | 6.9 | 9.9 |
| 10 sec Gel Strength | 1.25 | 1.25 | 1.25 | 4.9 |
| 10 min Gel Strength | 2 | 2 | 2 | 5.7 |

Shale Dispersion Tests

Dispersion tests measure the dispersion tendency of the shale sample after being exposed to a drilling fluid. Dispersion tests were carried out by rolling a pre-determined amount of sized shale cuttings in a hot-rolling cell with the drilling fluid to be tested. After hot-rolling the cell for 16 hours at 65° C., the shale cuttings are recovered on a screen, washed and dried in the oven for 24 hours at 105° C. Then, the sample was weighed to determine the cuttings recovery percentage. The results are presented as the percentage of cuttings recovery. A high value of cuttings recovery percentage is indicative of high-quality inhibition against dispersion since a large amount of the cuttings does not disperse.

The dispersion test was carried out as follows: 350 ml mud was prepared for each of the selected mud systems using standard test equipment and procedure, 2-4 mm shale cuttings were prepared using shale cores, 20 g of shale cuttings and 350 cc inhibitive drilling fluid were added into the hot roll cell, the cap was screwed tightly and then the cell was placed on the roller of the hot roll oven and rolled at 35 rpm for 16 hours at 65° C. After 16 hours, the cell was removed from the hot roll oven and the cell content was poured into a 500-micron sieve. The content of the sieve was washed with mildly running water to remove all shale pieces smaller than 500 microns, the cuttings were dried in an oven at 105° C. for 24 hours, and the weight of the dried shale was measured and recorded. Table 3 shows the shale cutting recovery weight after shale dispersion tests while the starting value is 20 grams.

TABLE 3
Shale Recovery Determined using Shale Dispersion Tests

| | Example 1 | Example 2 | Example 3 | Comp. Ex. 1 |
|---|---|---|---|---|
| Shale Type | Lower | Lower | Lower | Lower |
| | Silurian | Silurian | Silurian | Silurian |
| Weight Before | 20 | 20 | 20 | 20 |
| Dispersion Test (g) | | | | |
| Weight After | 18.75 | 19 | 19.45 | 17.21 |
| Dispersion Test (g) | | | | |

According to the results shown in Table 3, the exemplary drilling fluids including MSNs and no KCl, a conventional shale inhibitor, have higher shale recovery with increasing MSN content in comparison with drilling fluids system not including MSNs as a shale inhibitor.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A wellbore fluid composition comprising:
an aqueous base fluid; and
mesoporous silica nanoparticles (MSNs), wherein the MSNs are encapsulated in a surfactant.

2. The wellbore fluid composition of claim 1, wherein the MSNs are a shale inhibitor.

3. The wellbore fluid composition of claim 1, wherein the surfactant is a cationic surfactant.

4. The wellbore fluid composition of claim 3, wherein the cationic surfactant is cetyltrimethylammonium bromide (CTAB).

5. The wellbore fluid composition of claim 1, wherein the MSNs have an average particle size ranging from 100 to 200 nm, as measured by transmission electron microscopy (TEM).

6. The wellbore fluid composition of claim 1, wherein the MSNs comprise 30 to 50 wt % organic material, based on the total weight of the MSNs.

7. The wellbore fluid composition of claim 1, wherein the MSNs are MCM-41.

8. The wellbore fluid composition of claim 1, further comprising an additive selected from the group consisting of weighting agents, viscosifiers, wetting agents, corrosion inhibitors, oxygen scavengers, anti-oxidants, biocides, surfactants, dispersants, interfacial tension reducers, pH buffers, mutual solvents, thinning agents, and combinations thereof.

9. The wellbore fluid composition of claim 1, wherein the wellbore fluid has a plastic viscosity ranging from about 3.0 to about 6.0 cP at room temperature.

10. The wellbore fluid composition of claim 1, wherein the wellbore fluid has a yield point ranging from about 5.0 to about 15 lb/100 ft² (pounds per 100 square feet).

11. The wellbore fluid of claim 1, wherein the aqueous wellbore fluid is an aqueous drilling mud.

12. A method of drilling a wellbore, the method comprising:
circulating an aqueous drilling fluid into the wellbore while drilling, wherein the aqueous drilling fluid comprises mesoporous silica nanoparticles (MSNs) encapsulated by a surfactant; and
recovering shale cuttings from the aqueous drilling fluid.

13. The method of claim 12, wherein the MSNs are a shale inhibitor.

14. The method of claim 12, wherein the surfactant is a cationic surfactant.

15. The method of claim 12, wherein the surfactant is cetyltrimethylammonium bromide (CTAB).

16. The method of claim 12, wherein the MSNs have an average particle size ranging from about 100 to about 200 nm, as measured by transmission electron microscopy (TEM).

17. The method of claim 12, wherein the MSNs comprise about 30 to 50 wt % organic material, based on the total weight of the MSNs.

18. The method of claim 12, wherein the aqueous drilling fluid has a plastic viscosity ranging from about 3.0 to about 5.0 cP at room temperature.

19. The method of claim 12, wherein the aqueous drilling fluid has a yield point ranging from about 5.0 to about 15 lb/100 ft² (pounds per 100 square feet).

20. The method of claim 12, wherein the aqueous drilling fluid has a rolling recovery of shale cuttings of greater than 80%.
